(19) United States
(12) Patent Application Publication
(10) Pub. No.: US 2026/0180682 A1
(43) Pub. Date: Jun. 25, 2026

(54) COMMUNICATION APPARATUS, COMMUNICATION METHOD, AND NON-TRANSITORY COMPUTER READABLE MEDIUM

(71) Applicant: NEC Corporation, Minato-ku, Tokyo (JP)

(72) Inventor: Yohei HASEGAWA, Tokyo (JP)

(73) Assignee: NEC Corporation, Minato-ku, Tokyo (JP)

(21) Appl. No.: 18/712,759

(22) PCT Filed: Dec. 7, 2021
(86) PCT No.: PCT/JP2021/044966

§ 371 Date: May 23, 2024

(51) Int. Cl. H04B 10/079; H04B 10/077; H04B 10/114; H04B 10/27; H04B 10/516

(52) U.S. Cl. CPC H04B 10/07955; H04B 10/0775; H04B 10/1143; H04B 10/27; H04B 10/516

(57) ABSTRACT

A communication apparatus according to the present disclosure includes: a communication unit that connects the communication apparatus to an optical communication network that transmits an optical signal; a management unit that associates a transmission time for transmitting the optical signal between a virtual device on the optical communication network and the communication unit with identification information of the virtual device and manages the associated information; and a control unit that, when the control unit receives a request message requesting the transmission time for transmitting the optical signal between the virtual device and the communication unit, responds to the request message with a response message indicating the transmission time that is associated with the identification information of the virtual device and managed.

### TECHNICAL FIELD

The present disclosure relates to a communication apparatus, a communication method, and a program.

### BACKGROUND ART

The communication traffic volume has been increasing at an annual rate of more than 30% over the past 30 years. Therefore, large-scale networks are required in the Internet, mobile networks, inter-data-center networks, and the like.

Meanwhile, most of the large-scale networks in recent years are IP networks configured using Internet technologies. However, regarding IP networks, there is a problem that an apparatus cost and a power cost per communication capacity are high.

In order to achieve an efficient large-capacity communication in large-scale networks, it is expected that the size of an optical communication network with high power efficiency will become wide and large by reducing the number of transmission points of packets or frames of IP etc. and switching optical signals. In recent years, in optical signal processing, it has become possible to perform switching in a short time corresponding to the time it takes to perform packet forwarding.

However, an optical communication network looks like only one cable from the viewpoint of a user who establishes a connection with the optical communication network from the outside. That is, an optical communication network corresponds to a black box from the viewpoint of the user. Therefore, when the size of the optical communication network has become wide and large, there may be a problem in managing the quality of the optical communication network and monitoring failures.

Patent Literature 1 discloses a configuration of an optical node apparatus which converts only a header part of a packet to be transmitted over an optical communication network into an electric signal and performs processing based on the content of the converted header part. By converting only the header part of the packet from an optical signal to an electric signal, the optical node apparatus can send a packet to which information such as an error message has been added to the end node when a failure has occurred in the optical communication network.

Further, Patent Literature 2 discloses a configuration in which a base station and an antenna apparatus communicate with each other through an optical communication network.

### CITATION LIST

### Patent Literature

Patent Literature 1: Japanese Unexamined Patent Application Publication No. 2009-206978
Patent Literature 2: Japanese Unexamined Patent Application Publication No. 2019-140562

### SUMMARY OF INVENTION

### Technical Problem

When the communication quality or the failure state of an optical communication network is monitored by using the optical node apparatus disclosed in Patent Literature 1, it is necessary to perform conversion processing from an optical signal to an electric signal. However, it is required to simplify monitoring processing of an optical communication network in order to further make the communication quality stable.

One of the objects of the present disclosure is to provide a communication apparatus, a communication method, and a program by which monitoring processing of an optical communication network can be simplified.

### Solution to Problem

A communication apparatus according to a first example aspect of the present disclosure includes: a communication unit configured to connect the communication apparatus to an optical communication network configured to transmit an optical signal; a management unit configured to associate a transmission time for transmitting the optical signal between a virtual device on the optical communication network and the communication unit with identification information of the virtual device and manage the associated information; and a control unit configured to, when the control unit receives a request message requesting the transmission time for transmitting the optical signal between the virtual device and the communication unit, respond to the request message with a response message indicating the transmission time that is associated with the identification information of the virtual device and managed.

A communication method according to a second example aspect of the present disclosure includes: associating a transmission time for transmitting an optical signal between a virtual device on an optical communication network configured to transmit the optical signal and a communication apparatus with identification information of the virtual device and managing the associated information; and when a request message requesting the transmission time for transmitting the optical signal between the virtual device and the communication apparatus is received, responding to the request message with a response message indicating the transmission time that is associated with the identification information of the virtual device and managed.

A program according to a third example aspect of the present disclosure causes a computer to: associate a transmission time for transmitting an optical signal between a virtual device on an optical communication network configured and transmit the optical signal to a communication apparatus with identification information of the virtual device and manage the associated information; and when a request message requesting the transmission time for transmitting the optical signal between the virtual device and the communication apparatus is received, respond to the request message with a response message indicating the transmission time that is associated with the identification information of the virtual device and managed.

### Advantageous Effects of Invention

According to the present disclosure, it is possible to provide a communication apparatus, a communication method, and a program by which monitoring processing of the optical communication network can be simplified.

### BRIEF DESCRIPTION OF DRAWINGS

FIG. 1 is a configuration diagram of a communication apparatus according to a first example embodiment;

FIG. 2 is a diagram showing a flow of a communication method executed in the communication apparatus according to the first example embodiment;

FIG. 3 is a configuration diagram of a communication network according to a second example embodiment;

FIG. 4 is a configuration diagram of an optical communication device according to the second example embodiment;

FIG. 5 is a configuration diagram of a router according to the second example embodiment;

FIG. 6 is a diagram for explaining a flow of processes performed when a user apparatus according to the second example embodiment executes Ping;

FIG. 7 is a configuration diagram of the communication network according to the second example embodiment;

FIG. 8 is a configuration diagram of a communication network according to a third example embodiment;

FIG. 9 is a configuration diagram of a measuring instrument according to the third example embodiment;

FIG. 10 is a configuration diagram of the communication network according to the third example embodiment;

FIG. 11 is a configuration diagram of a communication network according to a fourth example embodiment;

FIG. 12 is a configuration diagram of an optical switch according to the fourth example embodiment; and

FIG. 13 is a configuration diagram of a communication apparatus and an optical communication device according to each of the example embodiments.

### EXAMPLE EMBODIMENT

### First Example Embodiment

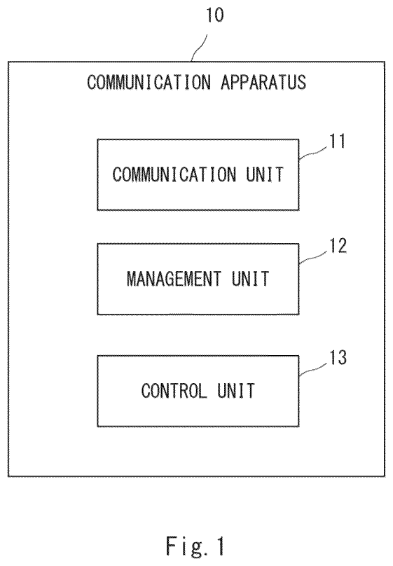

Example embodiments of the present disclosure will be described below with reference to the drawings. First, a configuration example of a communication apparatus 10 according to a first example embodiment will be described with reference to FIG. 1. The communication apparatus 10 may be a computer apparatus that operates when a processor executes a program stored in a memory. The communication apparatus 10 may be a router that converts an electrical signal into an optical signal or a gateway apparatus that converts an electrical signal into an optical signal.

The communication apparatus 10 includes a communication unit 11, a management unit 12, and a control unit 13. Each of the communication unit 11, the management unit 12, and the control unit 13 may be software or a module the processing of which is executed by a processor executing a program stored in a memory. Alternatively, each of the communication unit 11, the management unit 12, and the control unit 13 may be hardware such as a circuit or a chip.

The communication unit 11 is connected to an optical communication network that transmits an optical signal. The optical communication network may be, for example, a network composed of optical fibers. The optical communication network may be composed of optical communication devices. The optical communication device may be, for example, a splitter, an amplifier, an attenuator, or a switch. The optical communication network may be configured by connecting the optical communication devices to each other using optical fibers. The splitter separates or aggregates optical communication lines which are communication paths in the optical communication network. The amplifier amplifies an optical signal, while the attenuator attenuates an optical signal. The optical communication network transmits an optical signal to a terminal apparatus of the optical signal without converting the optical signal into an electric signal. The terminal apparatus of the optical signal may be, for example, a router that terminates a packet or an Optical Network Unit (ONU).

A process of connecting the communication unit 11 to the optical communication network may be a process of enabling the communication unit 11 to output an optical signal to the optical communication network and to receive an optical signal from the optical communication network.

The management unit 12 associates a transmission time for transmitting an optical signal between a virtual device on the optical communication network and the communication unit 11 with identification information of the virtual device and manages them. The optical communication network does not terminate an optical signal. Therefore, an external apparatus, which transmits data to the optical communication network through the communication apparatus 10, recognizes the optical communication network as one cable of an optical fiber etc. That is, the external apparatus cannot transmit a signal or a message addressed to the optical communication device in order to monitor or manage the optical communication device on the optical communication network. Further, even when the external apparatus transmits a signal or a message to the optical communication device, it cannot receive a response signal from the optical communication device.

The virtual device may be a virtual device that receives a signal from an external apparatus and further behaves as if it were transmitting a response signal to the external apparatus in the optical communication network. For example, the optical communication device may be defined as being a virtual device, and it may be defined that the virtual device is present at a position where the optical communication device is not actually present.

The transmission time for transmitting an optical signal between the virtual device and the communication unit 11 may be, for example, a period of time from when the virtual device transmits an optical signal to when the communication unit 11 receives the optical signal. Alternatively, it may be a period of time from when the communication unit 11 transmits an optical signal to when the virtual device receives the optical signal. The transmission time may be rephrased as a transmission delay, a delay time, or the like.

The transmission time, for example, may be determined in accordance with a distance between the virtual device and the communication unit 11. Alternatively, when the optical communication network is laid, the transmission time for transmitting an optical signal between the communication unit 11 and the virtual device may be measured using a measurement apparatus or the like.

The identification information of the virtual device may be, for example, address information assigned to the virtual device. The address information may be, for example, an IP address.

When the control unit 13 receives a request message requesting the transmission time for transmitting an optical signal between the virtual device and the communication unit 11, it responds to the request message with a response message indicating the transmission time associated with the identification information of the virtual device and managed.

The request message is transmitted to the communication apparatus 10 from, for example, an external apparatus that transmits data to the optical communication network through the communication apparatus 10 or receives data from the optical communication network through the communication apparatus 10. The external apparatus is a device managed by a user who uses the optical communication network, and may be referred to as a user device, a user apparatus, or the like. The user device or the user apparatus is a computer apparatus. The request message includes the identification information of the virtual device. When the control unit 13 receives the request message transmitted from the communication apparatus 10, it acquires from the management unit 12 information about the transmission time associated with the identification information of the virtual device and managed. Acquiring may be rephrased as, for example, selecting or extracting.

The control unit 13 may include, in the response message, information indicating the transmission time for transmitting an optical signal between the communication unit 11 and the virtual device. Alternatively, the control unit 13 may transmit the response message to the external apparatus through the communication unit 11 when the transmission time has elapsed after the control unit 13 has received the request message.

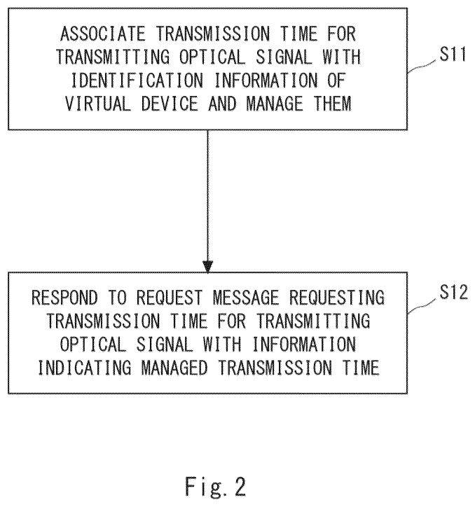

Next, a flow of communication processes performed in the communication apparatus 10 will be described with reference to FIG. 2. First, a transmission time for transmitting an optical signal between a virtual device on the optical communication network and the communication unit 11 are associated with identification information of the virtual device and managed (S11). Next, when the management unit 12 receives a request message requesting the transmission time for transmitting an optical signal between the virtual device and the communication unit 11, it responds to the request message with information indicating the transmission time associated with the identification information of the virtual device and managed (S12). The management unit 12 includes information indicating the transmission time in the response message and transmits the response message to an apparatus which is the transmission source of the request message.

As described above, the communication apparatus 10 transmits, to the external apparatus, a response message indicating the transmission time previously managed in response to the request message received from the external apparatus. By doing so, the communication apparatus 10 can transmit the response message indicating the transmission time to the external apparatus without converting the optical signal into an electric signal in the optical communication network. As a result, the communication apparatus 10 can simplify the monitoring processing of the optical communication network in the external apparatus.

Since the external apparatus can recognize the transmission time in a specific section in the optical communication network, the communication quality in the optical communication network can be controlled. As a result, the external apparatus can design a network using the optical communication network based on the communication quality in the optical communication network.

### Second Example Embodiment

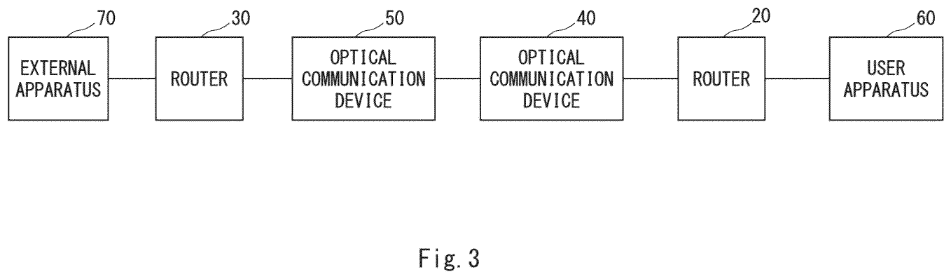

Next, a configuration example of a communication system according to a second example embodiment will be described with reference to FIG. 3. A communication network shown in FIG. 3 includes a router 20, a router 30, an optical communication device 40, an optical communication device 50, a user apparatus 60, and an external apparatus 70. The routers 20 and 30 may be referred to as router apparatuses. Each of the routers 20 and 30 corresponds to the communication apparatus 10 shown in FIG. 1. The optical communication devices 40 and 50 may be, for example, splitters, amplifiers, attenuators, or switches. The user apparatus 60 may be a computer apparatus having a communication function. The external apparatus 70 may be a server apparatus or a user apparatus. Further, the user apparatus 60 and the external apparatus 70 may be routers.

The routers 20 and 30 are connected to an optical communication network. That is, the router 20 converts an electrical signal received from the user apparatus 60 into an optical signal and transmits the optical signal to the optical communication device 40. Further, the router 20 converts an optical signal received from the optical communication device 40 into an electrical signal and transmits the electrical signal to the user apparatus 60. The router 30, like the router 20, converts an optical signal into an electrical signal and an electrical signal into an optical signal between the external apparatus 70 and the optical communication device 50. An apparatus having a function of converting an optical signal into an electrical signal and vice versa may be connected to the routers 20 and 30. Alternatively, the communication unit 11 included in each of the routers 20 and 30 may have a function of converting an optical signal into an electrical signal and vice versa.

The routers 20 and 30 are terminal points of an optical communication path set on the optical communication network. The routers 20 and 30 relay IP data transmission between the user apparatus 60 and the external apparatus 70. The routers 20 and 30 are IP routers, each of which uses Internet Control Message Protocol (ICMP) in which an echo request is set as communication for control for recognizing a network state. Further, when an Ethernet (Registered Trademark) switch or a Multi Protocol Label Switching (MPLS) router is used instead of the routers 20 and 30, Operations, Administration, Management (OAM) may be used as communication for control.

For example, the router 20 makes a pseudo reply or response to a message (ICMP message) about control communication received from the user apparatus 60, as if the optical communication device 40 or the optical communication device 50 had responded. Further, the routers 20 and 30 make a notification about a virtual IP communication path in the optical communication network to provide IP communication to the user apparatus 60 and the external apparatus 70 by using an IP path exchange protocol. The path exchange protocol may be, for example, Border Gateway Protocol (BGP).

The optical communication devices 40 and 50 measure power of an optical signal and detect a decrease in a signal level due to a failure occurred in the optical fiber or the like. The signal level may be rephrased as, for example, a light receiving level. For example, the optical communication devices 40 and 50 may detect a decrease in the signal level which has been so lowered that communication cannot be performed, or may detect a decrease in the signal level which has been so lowered that communication can be performed but degradation in communication quality occurs.

An example of a case where the router 20 makes a pseudo response to an ICMP message in which an echo request is set will be described below. The following description will be given in accordance with the assumption that the ICMP message in which an echo request is set is an ICMP Echo. Since the router 30 has a similar function as that of the router 20, a detailed description thereof will be omitted.

Since it is assumed that the optical communication network transmits an optical signal to the terminal apparatus without converting the optical signal into an electrical signal, the optical communication devices 40 and 50 composing the optical communication network do not perform processing about IP packets. That is, even when the user apparatus 60 uses the ICMP Echo, the optical communication devices 40 and 50 cannot respond to an ICMP message in which an echo reply is set. The following description will be given in accordance with the assumption that the ICMP message in which an echo reply is set is an ICMP Echo reply. As a result, the user apparatus 60 cannot detect the optical communication devices 40 and 50 composing the optical communication network by using a control signal of IP using ICMP or the like.

Since the user apparatus 60 cannot detect the optical communication devices 40 and 50, the user apparatus 60, for example, receives an ICMP Echo reply only from the routers 20 and 30. Therefore, the user apparatus 60 can measure only a transmission time for transmitting a signal between the user apparatus 60 and the router 20 or the router 30, and can only check continuity between the user apparatus 60 and the router 20 or the router 30. In the future, in a large-scale optical communication network in which the optical communication path is extended, a section serving as a black box becomes larger. Therefore, even when a failure that affects the communication performance has occurred in the optical communication network, a user who manages the user apparatus 60 cannot obtain a clue by which the user can know the cause of the failure.

Therefore, in the present disclosure, the routers 20 and 30 and the optical communication devices 40 and 50 have virtualization functions required for the routers 20 and 30 to make a pseudo response to the ICMP Echo.

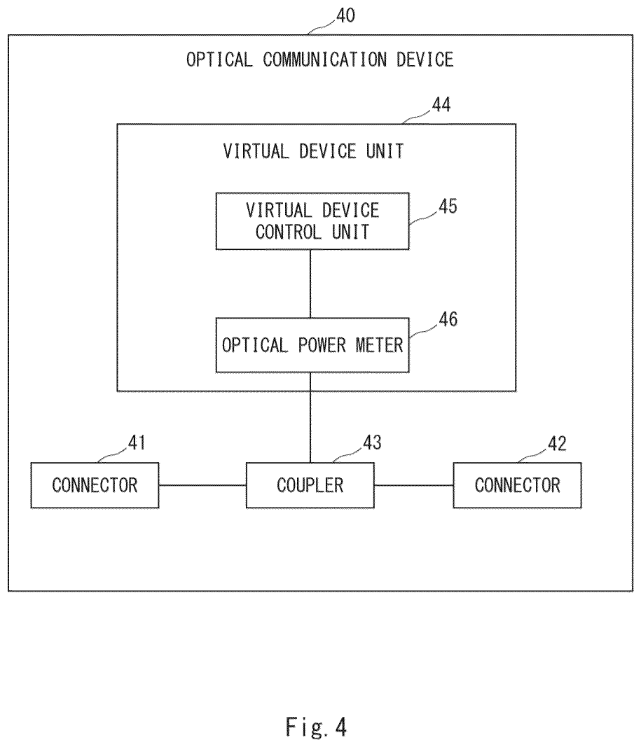

Next, a configuration example of the optical communication device 40 will be described with reference to FIG. 4. Since the configuration of the optical communication device 50 is similar to that of the optical communication device 40, a detailed description thereof will be omitted. The optical communication device 40 includes a connector 41, a connector 42, a coupler 43, and a virtual device unit 44. The virtual device unit 44 may be software or a module the processing of which is executed by a processor executing a program stored in a memory. Although FIG. 4 shows a configuration in which the optical communication device 40 includes the virtual device unit 44, the virtual device unit 44 may be provided in a device different from the optical communication device 40. In this case, the optical communication device 40 may be connected to the device on which the virtual device unit 44 is mounted through a wired cable, a network, or a wireless communication line.

The connectors 41 and 42 are, for example, optical fiber connectors that are connected to optical fibers forming an optical communication path. Further, a virtual address is assigned to each of the connectors 41 and 42. The virtual address, for example, may be in the form of an IP address. That is, the virtual address may be referred to as a virtual IP address. For example, an administrator that manages the optical communication network may determine the virtual addresses to be assigned to the connectors 41 and 42. The connector 41, for example, may be connected to the optical communication device 50 through an optical fiber, and the connector 42 may be connected to the router 20 through an optical fiber.

The coupler 43 is, for example, a fiber optic coupler that branches a part of the optical signal received from the connector 41 or the connector 42. For example, the coupler 43 outputs an optical signal received from the connector 41 or the connector 42 to the connector 42 or the connector 41, and outputs the branched part of the optical signal to the virtual device unit 44. Further, in FIG. 4, one connector 41, one connector 42, and one coupler 43 are shown on the assumption that one optical fiber is used for bidirectional communication. However, when it is used for unidirectional communication, two connectors 41, two connectors 42, and two couplers 43 may be used as a set.

The virtual device unit 44 includes a virtual device control unit 45 and an optical power meter 46. The optical power meter 46 measures power of an optical signal received from the coupler 43. The virtual device control unit 45 determines whether or not the power of the optical signal measured by the optical power meter 46 is within a preset range. In other words, the virtual device control unit 45 determines whether or not the power of the optical signal measured by the optical power meter 46 is smaller than or equal to the lower limit value of a preset range. The lower limit value of a preset range may be rephrased as a threshold.

The power of the optical signal that is smaller than or equal to the lower limit value of a preset range may be a signal level which has been so lowered that communication cannot be performed, or may be a signal level which has been so lowered that communication can be performed but degradation in the communication quality occurs. When it is determined that the power of the optical signal measured by the optical power meter 46 is smaller than or equal to the lower limit value of a preset range, there is a possibility that a failure has occurred in the optical fiber connected to the connector 41 or the connector 42.

The virtual device control unit 45 transmits a result of the determination to the router 20 to which the user apparatus 60 is connected. Further, the virtual device control unit 45 may transmit a result of the determination to the routers 20 and 30. The virtual device control unit 45 may transmit a result of the determination to the router 20 through, for example, a network different from the optical communication network configured using the routers 20 and 30 and the optical communication devices 40 and 50. When it is assumed that the optical communication network is a service network that provides communication services to the user apparatus 60 and the external apparatus 70, the network used by the optical communication device 40 to transmit a result of the determination to the router 20 may be a maintenance network. The maintenance network may be an IP network, and an optical communication network that is different from the optical communication network configured using the routers 20 and 30 and the optical communication devices 40 and 50.

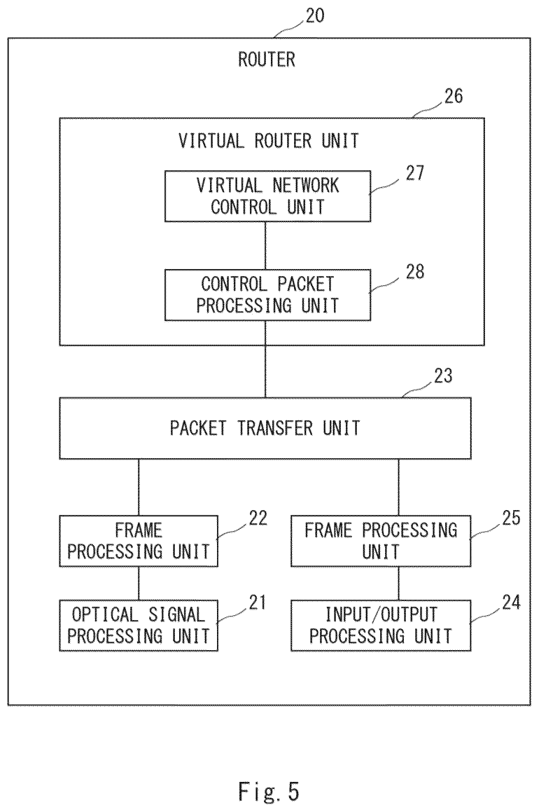

Next, a configuration example of the router 20 according to the second example embodiment will be described with reference to FIG. 5. Since the configuration of the router 30 is similar to that of the router 20, a detailed description thereof will be omitted. The router 20 includes an optical signal processing unit 21, a frame processing unit 22, a packet transfer unit 23, an input/output processing unit 24, a frame processing unit 25, and a virtual router unit 26. Each component composing the router 20 may be software or a module the processing of which is executed by a processor executing a program stored in a memory. Alternatively, each component composing the router 20 may be hardware such as a circuit or chip.

The optical signal processing unit 21 extracts a communication frame of the optical signal received from the optical communication network and outputs the extracted communication frame to the frame processing unit 22. An optical signal received from the optical communication network by the optical signal processing unit 21 may be rephrased as an optical signal received through an optical fiber. Alternatively, the optical signal processing unit 21 transmits the communication frame received from the frame processing unit 22 to the optical communication network as an optical signal. A virtual address is assigned to the optical signal processing unit 21.

The frame processing unit 22 extracts a packet from the communication frame received from the optical signal processing unit 21 and outputs the extracted packet to the packet transfer unit 23. Alternatively, the frame processing unit 22 frames the packet received from the packet transfer unit 23 and outputs the framed communication frame to the optical signal processing unit 21.

The input/output processing unit 24 extracts a communication frame of the communication data received from the user apparatus 60 and outputs the extracted communication frame to the frame processing unit 25. Alternatively, the input/output processing unit 24 transmits the communication frame received from the frame processing unit 25 to the user apparatus 60.

The packet transfer unit 23 refers to the destination indicated in a packet and transfers the packet to the frame processing unit 22 or the frame processing unit 25. Further, when the packet transfer unit 23 receives a control packet the destination of which is a virtual address assigned to the connector of the optical communication device 40 or 50, it outputs the control packet to the control packet processing unit 28. It is assumed here that the control packet processing unit 28 receives, as a control packet, an ICMP Echo in which a virtual address is set as the destination.

Next, the function or the operation of the virtual router unit 26 will be described. The virtual router unit 26 includes a virtual network control unit 27 and a control packet processing unit 28.

The control packet processing unit 28 outputs the control packet received from the packet transfer unit 23 to the virtual network control unit 27. Alternatively, the control packet processing unit 28 outputs the control packet received from the virtual network control unit 27 to the packet transfer unit 23.

The virtual network control unit 27 holds information about a round-trip transmission time for transmitting an optical signal between the optical signal processing unit 21 and each of the optical communication devices 40 and 50 present in the optical communication network in advance. For example, the virtual network control unit 27 associates the virtual address assigned to the optical communication device with the round-trip transmission time for transmitting an optical signal and manages them. Specifically, the virtual network control unit 27 associates the round-trip transmission time for transmitting an optical signal between the optical signal processing unit 21 and the optical communication device 40 with the virtual address assigned to the connector 42 of the optical communication device 40 and manages them. Further, the virtual network control unit 27 associates the round-trip transmission time for transmitting an optical signal between the optical signal processing unit 21 and the optical communication device 50 with the virtual address assigned to the connector 42 of the optical communication device 50 and manages them.

Further, the virtual network control unit 27 manages results of the determination as to the power of the optical signals in the optical communication devices 40 and 50 received through the maintenance network. The results of the determination indicate, for example, whether or not the power of the optical signal received in the optical communication devices 40 and 50 is within a preset range.

When the virtual network control unit 27 receives an ICMP Echo in which a virtual address is set as the destination from the packet transfer unit 23, the virtual network control unit 27 specifies a round-trip transmission time for transmitting an optical signal between it and an optical communication device to which the virtual address is assigned. Further, the virtual network control unit 27 determines whether or not the power of the optical signal is within a preset range as a result of the determination associated with the virtual address.

When the virtual network control unit 27 determines that the power of the optical signal is within a preset range as a result of the determination associated with the virtual address, the virtual network control unit 27 generates an ICMP Echo reply in which the virtual address set as the destination is set as a transmission source. The virtual network control unit 27 outputs the generated ICMP Echo reply to the control packet processing unit 28. When the transmission source of the ICMP Echo is the user apparatus 60, the virtual network control unit 27 sets the user apparatus 60 as the destination of the ICMP Echo reply. Further, when the virtual network control unit 27 determines that the power of the optical signal is not within a preset range as a result of the determination associated with the virtual address, the virtual network control unit 27 does not generate an ICMP Echo reply. That is, when the virtual network control unit 27 determines that the power of the optical signal is not within a preset range, it does not respond to the user apparatus 60 with an ICMP Echo reply.

When the virtual network control unit 27 outputs an ICMP Echo reply to the control packet processing unit 28, it may output the ICMP Echo reply to the control packet processing unit 28 at a timing when the specified round-trip transmission time since the input/output processing unit 24 has received the ICMP Echo has elapsed. Alternatively, when the input/output processing unit 24 transmits the ICMP Echo reply to the user apparatus 60, the virtual network control unit 27 may output the ICMP Echo reply to the control packet processing unit 28 so that the round-trip transmission time since the input/output processing unit 24 has received the ICMP Echo elapses.

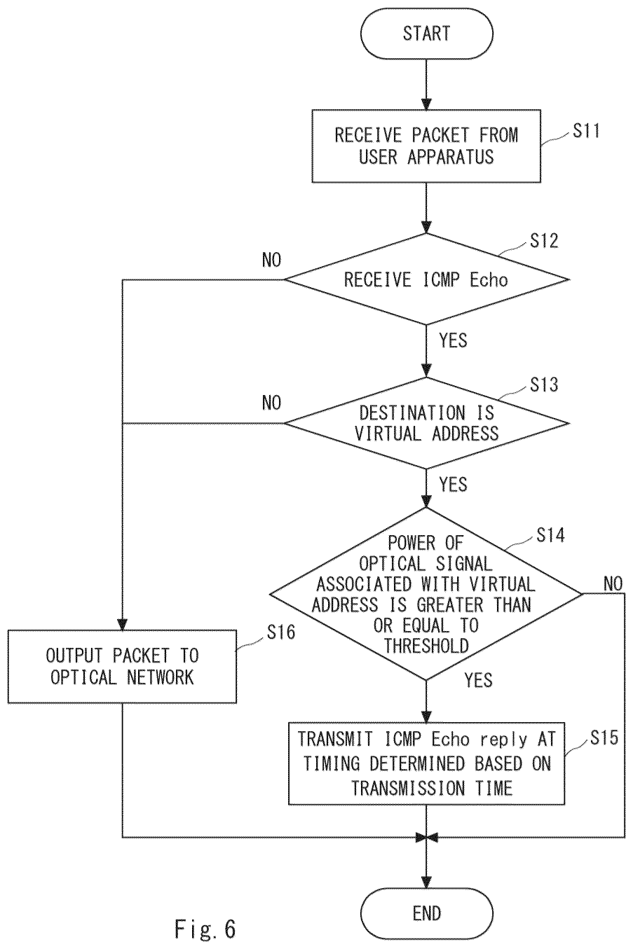

Next, a flow of processes performed by the router 20 when the user apparatus 60 uses Ping as a tool for measuring a round-trip transmission time for transmitting an optical signal between it and the optical communication device 40 will be described with reference to FIG. 6. Ping is used to measure a Round Trip Time (RTT) until an ICMP Echo is transmitted and an ICMP Echo reply is received.

First, the input/output processing unit 24 receives a packet from the user apparatus 60 (S11). Next, the packet transfer unit 23 determines whether or not the received packet is an ICMP Echo (S12). In Step S12, when the packet transfer unit 23 determines that the ICMP Echo has been received, the virtual network control unit 27 determines whether or not the destination of the ICMP Echo is a virtual address (S13).

In Step S13, when the virtual network control unit 27 determines that the destination of the ICMP Echo is a virtual address, it determines whether or not the power of an optical signal associated with the virtual address is within a preset range, that is, greater than or equal to a threshold (S14).

When the virtual network control unit 27 determines in Step S14 that the power of an optical signal associated with the virtual address is greater than or equal to a threshold, the virtual network control unit 27 generates an ICMP Echo reply, and the input/output processing unit 24 transmits the ICMP Echo reply to the user apparatus 60 (S15). Note that the virtual network control unit 27 determines a timing at which the ICMP Echo reply is output based on the round-trip transmission time associated with the virtual address and managed. For example, the virtual network control unit 27 may output the ICMP Echo reply to the control packet processing unit 28 at a timing when the round-trip transmission time has elapsed. Alternatively, when the input/output processing unit 24 transmits the ICMP Echo reply to the user apparatus 60, the virtual network control unit 27 may output the ICMP Echo reply to the control packet processing unit 28 so that the round-trip transmission time since the input/output processing unit 24 has received the ICMP Echo elapses. The virtual network control unit 27 sets a virtual address as a transmission source address of the ICMP Echo reply.

In Step S12, when the packet transfer unit 23 determines that the received packet is not an ICMP Echo, it outputs the received packet to the frame processing unit 22, and the optical signal processing unit 21 transmits the optical signal including the packet to the optical communication network (S16).

In Step S13, when the virtual network control unit 27 determines that the destination of the ICMP Echo is not a virtual address, it outputs the packet to the optical signal processing unit 21 through the packet transfer unit 23. Further, the optical signal processing unit 21 transmits the optical signal including the packet to the optical communication network (S16).

In Step S14, when the virtual network control unit 27 determines that the power of the optical signal associated with the virtual address is below a threshold, it does not respond to the ICMP Echo with the ICMP Echo reply. In other words, in Step S14, when the virtual network control unit 27 determines that the power of the optical signal associated with the virtual address is below a threshold, the process is ended, that is, the process in Step S15 is not performed.

As described above, the router 20 responds with an ICMP Echo reply to an ICMP Echo in which a virtual address assigned to the optical communication device 40 or 50 is set. Further, the router 20 responds with the ICMP Echo reply based on the round-trip transmission time for transmitting an optical signal between the router 20 and the optical communication device 40 or 50. As a result, the user apparatus 60 can respond with the ICMP Echo reply after a period of time substantially similar to that when the ICMP Echo is transmitted to the optical communication device 40 or 50 and the ICMP Echo reply transmitted from the optical communication device 40 or 50 is received has elapsed.

Further, the router 20 does not respond with the ICMP Echo reply when the destination of the ICMP Echo is a virtual address assigned to the optical communication device 40 and the power of the optical signal in the optical communication device 40 is below a threshold. Thus, the user apparatus 60 can detect that a failure has occurred between the router 20 and the optical communication device 40 or estimate that a failure has occurred.

Note that, in the second example embodiment, although operations using ICMP Echo have been mainly described, continuity checking and delay checking, in which request/response operations similar to the ICMP Echo such as Ethernet (registered trademark) OAM (may be referred to as Ether OAM) and MPLS OAM are performed, may be used.

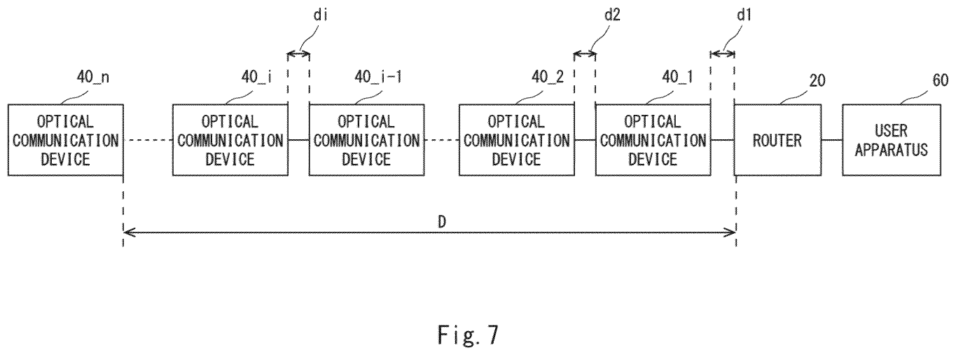

Further, in the communication system shown in FIG. 3, although a configuration example in which two optical communication devices are present in the optical communication network between routers has been described, the number of optical communication devices is not limited to two. For example, as shown in FIG. 7, the number of optical communication devices may be generalized so as to be n (n is an integer of one or greater). FIG. 7 shows a configuration example in which optical communication device 40_1 to 40_n are present. It is assumed that virtual addresses V1 to Vn are assigned to the optical communication devices 40_1 to 40_n, respectively.

It is assumed that a transmission time di (i=1 to n) in an optical fiber section is measured when, for example, the optical fiber is laid. It is assumed that di indicates a transmission time in an optical fiber section between the optical communication device 40_i−1 and the optical communication device 40_i. In this case, a round-trip transmission time Di for transmitting an optical signal between the router 20 and the optical communication device 40_i is expressed using the following expression (1).

$${D}_{i} = {\sum }_{j = 1}^{1} 2 {d}_{j} \qquad Expression ( 1 )$$

The router 20 records information about the round-trip transmission time to each of the optical communication devices 40_1 to 40_n.

### Third Example Embodiment

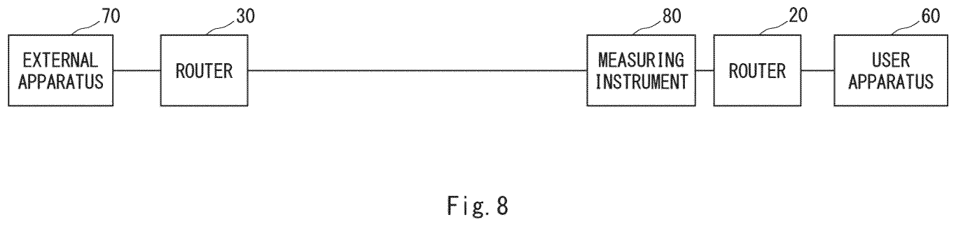

Next, a configuration example of a communication system according to a third example embodiment will be described with reference to FIG. 8. In the communication system shown in FIG. 8, a measuring instrument 80 is disposed between the router 20 and the router 30. Further, the measuring instrument 80 may be disposed at a position near the router 20. The measuring instrument 80 is used to detect whether or not a failure has occurred in the optical communication network using an optical pulse signal.

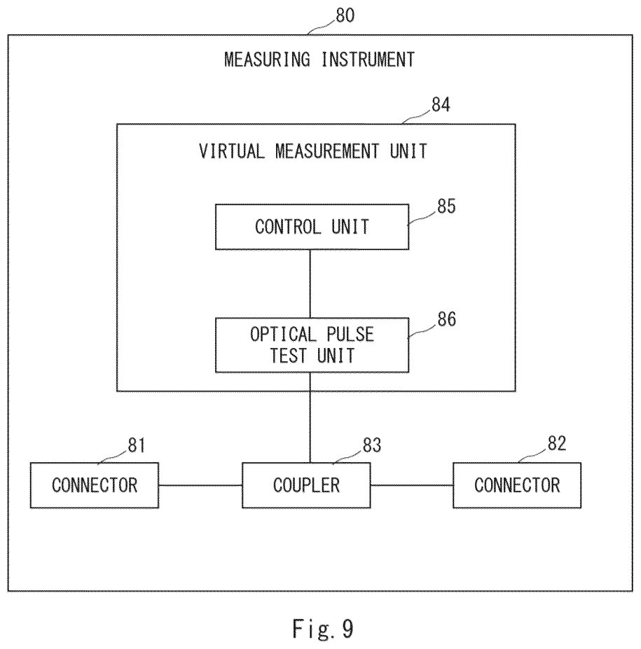

Next, a configuration example of the measuring instrument 80 according to the third example embodiment will be described with reference to FIG. 9. The measuring instrument 80 may be a computer apparatus that operates when a processor executes a program stored in a memory.

The measuring instrument 80 includes a connector 81, a connector 82, a coupler 83, and a virtual measurement unit 84. Since the connector 81, the connector 82, and the coupler 83 are similar to the connector 41, the connector 42, and the coupler 43 shown in FIG. 4, detailed descriptions thereof will be omitted. The connector 81 is connected to an optical fiber between the measuring instrument 80 and the router 30. The connector 82 is connected to an optical fiber between the measuring instrument 80 and the router 20.

The virtual measurement unit 84 includes a control unit 85 and an optical pulse test unit 86. The optical pulse test unit 86 may be referred to, for example, as an Optical Time Domain Reflectometer (OTDR). The optical pulse test unit 86 may be used, for example, to detect a place in the optical fiber where breakage has occurred. The optical pulse test unit 86 detects a failure that has occurred in the optical fiber by transmitting an optical pulse signal and observing the reflection of the optical pulse signal, and further specifies a position where the failure has occurred. The position where the failure has occurred may be specified, for example, by a distance from the measuring instrument 80. The optical pulse test unit 86 transmits the optical pulse signal through the connector 81 in the direction of the router 30. That is, the optical pulse test unit 86 is used to determine whether or not a failure has occurred in the optical fiber laid between the measuring instrument 80 and the router 30.

The optical pulse test unit 86 may periodically transmit an optical pulse signal, or may transmit an optical pulse signal at any timing in response to an instruction from an administrator or the like who operates the measuring instrument 80. The optical pulse test unit 86 determines whether or not a failure has occurred in the optical communication network by transmitting an optical pulse signal and then observing the reflection of the optical pulse signal. The optical pulse test unit 86 outputs a result of the determination to the control unit 85. The control unit 85 transmits the result of the determination to the virtual network control unit 27 of the router 20. The result of the determination includes information indicating whether or not a failure has occurred and, when a failure has occurred, information specifying a position where the failure has occurred. The control unit 85 may transmit the result of the determination to the router 20 through the connector 82 or through the maintenance network.

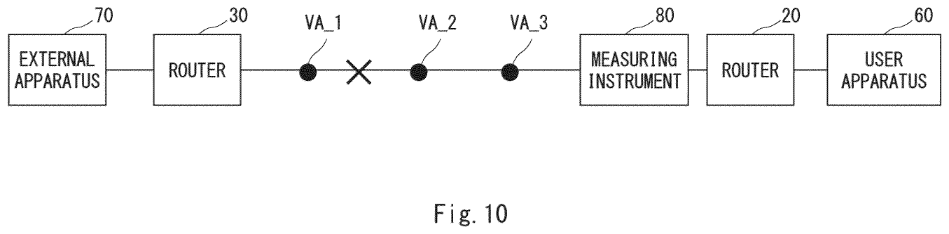

The router 20 determines whether or not to respond to the ICMP Echo received from the user apparatus 60 with an ICMP Echo reply by using the result of the determination received from the measuring instrument 80. A virtual address assigned to a virtual device on an optical communication network will be described below with reference to FIG. 10. As shown in FIG. 10, it is assumed that a virtual device to which the virtual address VA_1 is assigned, a virtual device to which the virtual address VA_2 is assigned, and a virtual device to which the virtual address VA_3 is assigned are present between the router 30 and the measuring instrument 80. Although the virtual device is not actually disposed as a physical device, the router 20 notifies the user apparatus 60 about the virtual address VA_1, the virtual address VA_2, and the virtual address VA_3 using a route exchange protocol. Alternatively, configuration information indicating a network configuration in which devices to which the virtual address VA_1, the virtual address VA_2, and the virtual address VA_3 are assigned are present between the router 20 and the router 30 may be sent to the user apparatus 60. As a result, the user apparatus 60 recognizes that devices to which the virtual address VA_1, the virtual address VA_2, and the virtual address VA_3 are assigned are actually present between the router 20 and the router 30.

For example, the user apparatus 60 transmits an ICMP Echo in which the virtual address VA_1 is set to the router 20 in order to verify the reachability to the virtual address VA_1. The user apparatus 60 may transmit an ICMP Echo in which the virtual address VA_2 or the virtual address VA_3 is set to the router 20 in order to verify the reachability to the virtual address VA_2 or the virtual address VA_3.

It is assumed that the router 20 has, as a result of receiving the determination from the measuring instrument 80, been alerted to the fact that a failure has occurred in a position between the virtual device to which the virtual address VA_1 is assigned and the virtual device to which the virtual address VA_2 is assigned. In this case, the router 20 does not respond to the ICMP Echo in which the virtual address VA_1 is set with an ICMP Echo reply. On the other hand, the router 20 transmits an ICMP Echo reply to the ICMP Echo in which the virtual address VA_2 or the virtual address VA_3 is set. When the router 20 transmits an ICMP Echo reply in response to the ICMP Echo in which the virtual address VA_2 or the virtual address VA_3 is set, the router 20 determines a timing at which it transmits an ICMP Echo reply in accordance with a round-trip transmission time for transmitting an optical signal between the router 20 and the virtual device.

The user apparatus 60 can estimate a position where the failure has occurred in accordance with whether or not an ICMP Echo reply is received from the router 20. For example, it is assumed that the user apparatus 60 does not receive an ICMP Echo reply in response to the ICMP Echo in which the virtual address VA_1 is set, but receives an ICMP Echo reply in response to the ICMP Echo in which the virtual address VA_2 is set. In this case, the user apparatus 60 can estimate that a failure has occurred between the position of the virtual device to which the virtual address VA_1 is assigned and the position of the virtual device to which the virtual address VA_2 is assigned.

As described above, the router 20 can detect a position in the optical fiber where a failure has occurred as a failure of the link between the virtual devices. Further, the user apparatus 60 can detect a position where a failure has occurred in accordance with a result of the reception of the ICMP Echo reply.

### Fourth Example Embodiment

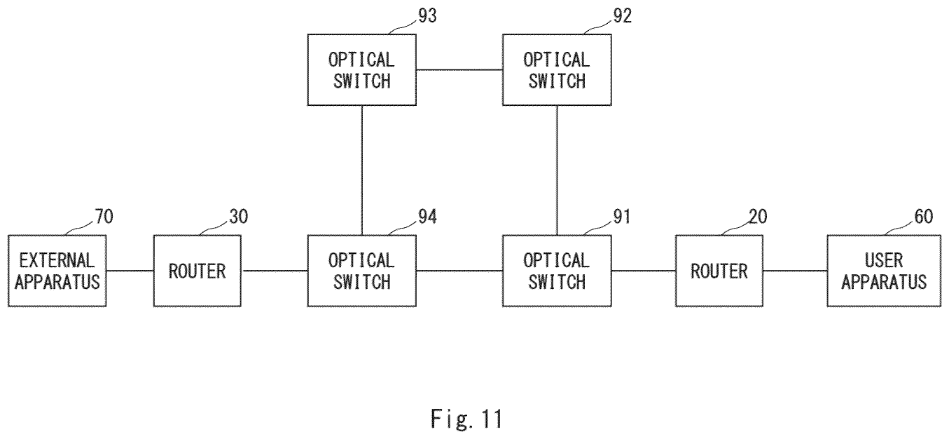

Next, a configuration example of a communication network according to a fourth example embodiment will be described with reference to FIG. 11. FIG. 11 shows a configuration in which optical switches 91 to 94 are used in place of the optical communication devices 40 and 50 shown in FIG. 3. FIG. 11 shows a configuration in which the optical switch 91 is connected to the router 20, the optical switch 92, and an optical switch 94 through an optical fiber, and the optical switch 92 is connected to the optical switch 91 and the optical switch 93 through an optical fiber. FIG. 11 further shows a configuration in which the optical switch 93 is connected to the optical switch 92 and the optical switch 94 through an optical fiber, and the optical switch 94 is connected to the router 30, the optical switch 93, and the optical switch 91 through an optical fiber. It is assumed that a virtual address is assigned to each of the optical switches 91 to 94.

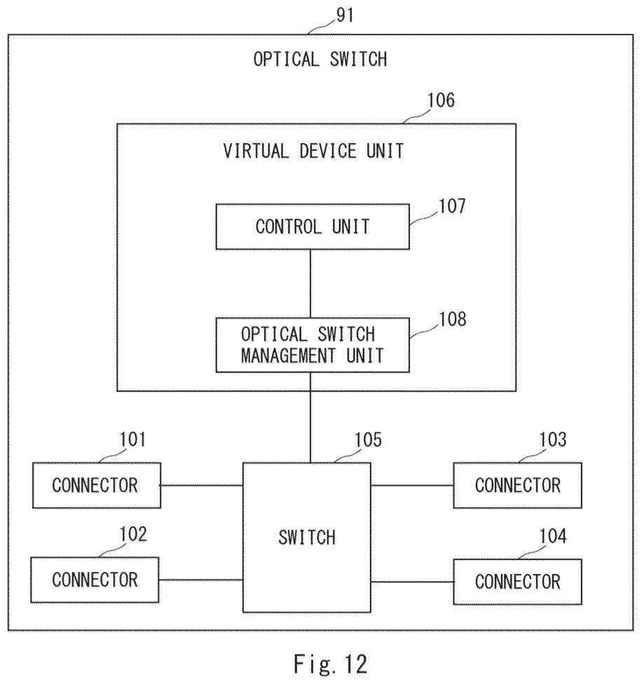

Next, a configuration example of the optical switch 91 will be described with reference to FIG. 12. Since the configuration of each of the optical switches 92 to 94 is similar to that of the optical switch 91, detailed descriptions thereof will be omitted.

The optical switch 91 includes connectors 101 to 104, a switch 105, and a virtual device unit 106. The switch 105 outputs optical signals received from the connectors 101 to 104 to one of the connectors 101 to 104 and an optical switch management unit 108. Further, the optical switch 91 outputs a detection state of an optical signal in each of the connectors 101 to 104 to the optical switch management unit 108. In other words, the optical switch 91 outputs a conduction state in each of the connectors 101 to 104 to the optical switch management unit 108. That is, the switch 105 determines whether or not optical signals can be detected in the connectors 101 to 104 and outputs a result of the determination to the optical switch management unit 108.

The optical switch management unit 108 determines whether or not a failure has occurred in the optical fibers connected to the respective connectors based on the result of the determination received from the switch 105. For example, the optical switch management unit 108 may determine that a failure has occurred in the optical fiber connected to the connector in which an optical signal cannot be detected.

The control unit 107 transmits a result of the determination by the optical switch management unit 108 to the routers 20 and 30. The result of the determination includes information about which connector the optical fiber in which a failure has occurred is connected to. The control unit 107 may transmit a result of the determination to the routers 20 and 30, for example, through the maintenance network.

The router 20 specifies in which section of the optical fiber a failure has occurred based on the results of the determination received from the optical switches 91 to 94. Further, in a case where the router 20 receives an ICMP Echo in which a virtual address is set from the user apparatus 60, the router 20 does not respond with an ICMP Echo reply when the virtual address of the optical switch that performs communication through the optical fiber in which a failure has occurred is set in the ICMP Echo. The router 20 responds with an ICMP Echo reply when the virtual address of the optical switch that is not required to perform communication through the optical fiber in which a failure has occurred is set in the ICMP Echo.

As described above, the router 20 and the router 30 can specify a position in the optical communication network where a failure has occurred even when the path is branched using the optical switches composing the optical communication network. Further, the router 20 can control whether or not to respond to the ICMP Echo received from the user apparatus 60 with an ICMP Echo reply in accordance with a state of the occurrence of a failure. As a result, the external apparatus such as the user apparatus 60 can detect a position in the optical communication network where a failure has occurred.

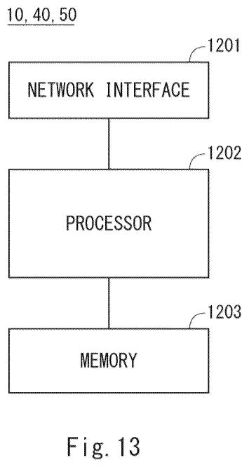

FIG. 13 is a block diagram showing a configuration example of the communication apparatus 10, the optical communication device 40, and the optical communication device 50 (hereinafter referred to as the communication apparatus 10 and the like). Referring to FIG. 13, the communication apparatus 10 and the like include a network interface 1201, a processor 1202, and a memory 1203. The network interface 1201 may be used to communicate with a network node. The network interface 1201 may include, for example, a network interface card (NIC) that is in conformity with IEEE 802.3 series. IEEE stands for Institute of Electrical and Electronics Engineers.

The processor 1202 loads software (a computer program) from the memory 1203 and executes the loaded software, thereby performing processing of the communication apparatus 10 and the like described with reference to the flowcharts in the above example embodiments. The processor 1202 may be, for example, a microprocessor, an MPU, or a CPU. The processor 1202 may include a plurality of processors.

The memory 1203 is composed of a combination of a volatile memory and a non-volatile memory. The memory 1203 may include storage located separately from processor 1202. In this case, the processor 1202 may access the memory 1203 through an Input/Output (I/O) interface (not shown).

In the example shown in FIG. 13, the memory 1203 is used to store software modules. The processor 1202 loads these software modules from the memory 1203 and executes the loaded software modules, so that the processor 1202 can perform processing of the communication apparatus 10 and the like described in the above example embodiments.

As described above with reference to FIG. 13, each of the processors included in the communication apparatus 10 and the like in the above-described example embodiments executes one or a plurality of programs including instructions for causing a computer to perform the algorithm described with reference to the drawings.

In the example described above, the program includes instructions (or software codes) that, when loaded into a computer, cause the computer to perform one or more of the functions described in the example embodiments. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (Registered Trademark) disc or other types of optical disc storage, a magnetic cassette, a magnetic tape, and a magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

Note that the present disclosure is not limited to the above-described example embodiments and may be changed as appropriate without departing from the scope and spirit of the present disclosure.

### REFERENCE SIGNS LIST

10 COMMUNICATION APPARATUS
11 COMMUNICATION UNIT
12 MANAGEMENT UNIT
13 CONTROL UNIT
20 ROUTER
21 OPTICAL SIGNAL PROCESSING UNIT
22 FRAME PROCESSING UNIT
23 PACKET TRANSFER UNIT
24 INPUT/OUTPUT PROCESSING UNIT
25 FRAME PROCESSING UNIT
26 VIRTUAL ROUTER UNIT
27 VIRTUAL NETWORK CONTROL UNIT
28 CONTROL PACKET PROCESSING UNIT
30 ROUTER
40 OPTICAL COMMUNICATION DEVICE
41 CONNECTOR
42 CONNECTOR
43 COUPLER
44 VIRTUAL DEVICE UNIT
45 VIRTUAL DEVICE CONTROL UNIT
46 OPTICAL POWER METER
50 OPTICAL COMMUNICATION DEVICE
60 USER APPARATUS
70 EXTERNAL APPARATUS
80 MEASURING INSTRUMENT
81 CONNECTOR
82 CONNECTOR
83 COUPLER
84 VIRTUAL MEASUREMENT UNIT
85 CONTROL UNIT
86 OPTICAL PULSE TEST UNIT
91 OPTICAL SWITCH
92 OPTICAL SWITCH
93 OPTICAL SWITCH
94 OPTICAL SWITCH
101 CONNECTOR
102 CONNECTOR
103 CONNECTOR
104 CONNECTOR
105 SWITCH
106 VIRTUAL DEVICE UNIT
107 CONTROL UNIT
108 OPTICAL SWITCH MANAGEMENT UNIT

What is claimed is:

1. A communication apparatus comprising:
at least one memory storing instructions, and
at least one processor configured to execute the instructions to;
connect the communication apparatus to an optical communication network configured to transmit an optical signal;
associate a transmission time for transmitting the optical signal between a virtual device on the optical communication network and the communication unit with identification information of the virtual device and manage the associated information; and
when receiving a request message requesting the transmission time for transmitting the optical signal between the virtual device and the communication apparatus, respond to the request message with a response message indicating the transmission time that is associated with the identification information of the virtual device and managed.

2. The communication apparatus according to claim 1, wherein
the at least one processor is further configured to execute the instructions to use virtual address information assigned to the virtual device as the identification information of the virtual device, and respond to the request message with a response message indicating the transmission time that is associated with the virtual address information and managed when the request message including the virtual address information is received.

3. The communication apparatus according to claim 2, wherein the at least one processor is further configured to execute the instructions to set the virtual address information included in the request message as a transmission source address of the response message.

4. The communication apparatus according to claim 1, wherein the at least one processor is further configured to execute the instructions to respond with the response message after the transmission time since the control unit has received the request message has elapsed when the request message requesting the transmission time for transmitting the optical signal between the virtual device and the communication apparatus is received.

5. The communication apparatus according to claim 1, wherein the at least one processor is further configured to execute the instructions not to respond to the request message when a failure has occurred in the virtual device or in a section between the virtual device and the communication unit.

6. The communication apparatus according to claim 5, wherein the failure is detected by using reflection of an optical pulse signal.

7. The communication apparatus according to claim 1, wherein the at least one processor is further configured to execute the instructions to determine whether or not a received message received from an external apparatus corresponds to the request message, and send the response message to the external apparatus when the communication apparatus determines that the received message corresponds to the request message, while output the received message to the optical communication network when the communication apparatus determines that the received message does not correspond to the request message.

8. A communication method performed in a communication apparatus, the communication method comprising:
associating a transmission time for transmitting an optical signal between a virtual device on an optical communication network configured and transmit the optical signal to a communication apparatus with identification information of the virtual device and managing the associated information; and
when a request message requesting the transmission time for transmitting the optical signal between the virtual device and the communication apparatus is received, responding to the request message with a response message indicating the transmission time that is associated with the identification information of the virtual device and managed.

9. A non-transitory computer readable medium storing a program for causing a computer to:
associate a transmission time for transmitting an optical signal between a virtual device on an optical communication network configured to transmit the optical signal and a communication apparatus with identification information of the virtual device and manage the associated information; and
when a request message requesting the transmission time for transmitting the optical signal between the virtual device and the communication apparatus is received, respond to the request message with a response message indicating the transmission time that is associated with the identification information of the virtual device and managed.
